(19) United States
(12) Patent Application Publication
(10) Pub. No.: US 2015/0336031 A1
(43) Pub. Date: Nov. 26, 2015

(54) SOLID/FLUID SEPARATION DEVICE AND METHOD

(71) Applicants: Richard Romeo LEHOUX, Windsor (CA); Christopher Bruce BRADT, LaSalle (CA); Dave SALT, Mississauga (CA)

(72) Inventors: Richard Romeo LEHOUX, Windsor (CA); Christopher Bruce BRADT, LaSalle (CA); Dave SALT, Mississauga (CA)

(21) Appl. No.: 14/718,686

(22) Filed: May 21, 2015

Related U.S. Application Data
(60) Provisional application No. 62/001,845, filed on May 22, 2014.

(51) Int. Cl. B01D 25/12; B01D 35/30

(52) U.S. Cl. CPC B01D 25/12; B01D 35/30

(57) ABSTRACT

A solid/fluid separation module and apparatus enables treatment of solid/fluid mixtures to generate a filtered mass having a solids content above 50%. A filter unit with stacked filter plates and filter passages recessed into a face of each filter plate is provided.

This application claims priority under 35 U.S. C. §119(e) to U.S. Provisional Patent Application Ser. No. 62/001,845, filed May 22, 2014, which is incorporated herein in its entirety by reference.

### FIELD OF THE INVENTION

The present disclosure is broadly concerned with solid/fluid separation apparatus and methods for the separation of different types of solid/fluid mixtures. In addition, the present disclosure relates to rotary presses, in particular improved screw press, devices, which can be used for the separation of a wide variety of solid/fluid mixtures and slurries of varying densities, solids contents and types of solids and fluids or liquids.

### BACKGROUND OF THE INVENTION

Various processes for the treatment of solid/fluid mixtures by solid/fluid separation are known. They generally require significant residence time and high pressure and, at times, high temperature. Conventional solid/fluid separation equipment is not satisfactory for the achievement of high solid/fluid separation rates and for separated solids with low liquid content.

Processes including the washing and subsequent concentration of a liquid slurry under pressure require solid/liquid separation equipment able to operate under pressure without clogging. For example, a key component of process efficiency in the pretreatment of lignocellulosic biomass is the ability to wash and squeeze hydrolyzed hemi-cellulose sugars, toxins, inhibitors and/or other extractives from the solid biomass/cellulose fraction. It is difficult with conventional equipment to effectively separate solids from liquid under the high heat and pressure required for cellulose pre-treatment.

Many biomass-to-ethanol processes generate a wet fiber slurry from which dissolved compounds, gases and liquids must be separated at various process steps to isolate a solid fibrous portion. Solid/fluid separation is generally done by filtration and either in batch operation, with filter presses, or continuously by way of rotary presses, such as screw presses.

Solid/fluid or solid/liquid separation is also necessary in many other commercial processes, such as food processing (oil extraction), reduction of waste stream volume in wet extraction processes, dewatering processes, or suspended solids removal.

Commercially available screw presses can be used to remove moisture from a solid/liquid slurry. The de-liquefied solids cake achievable with conventional presses generally contains only 40-50% solids, the leftover moisture being predominantly water. This level of separation may be satisfactory when the filtration step is followed by another dilution or treatment step, but not when maximum dewatering of the slurry is desired. The unsatisfactory low solids content is due to the relatively low maximum pressure a conventional screw press can handle, which is generally not more than about 100-150 psig of separation pressure. Commercial Modular Screw Devices (MSD's) combined with drainer screws can be used, which can run at higher pressures of up to 300 psi. However, their drawbacks are their inherent cost, complexity and continued filter cake limitation of no more than 50% solids content.

During solid/fluid separation, the amount of liquid remaining in the solid fraction is dependent on the amount of separating pressure applied, the thickness of the solids cake, and the porosity of the filter. The porosity of the filter is dependent on the number and size of the filter pores. A reduction in pressure, an increase in cake thickness, or a decrease in porosity of the filter, will all result in a decrease in the degree of liquid/solid separation and the ultimate degree of dryness of the solids fraction.

For a particular solids cake thickness and filter porosity, maximum separation is achieved at the highest separating pressure possible. Moreover, for a particular solids cake thickness and separating pressure, maximum separation is dependent solely on the pore size of the filter.

High separating pressures unfortunately require strong filter media, which are able to withstand the separating pressure within the press, making control of the filtering process difficult and the required equipment very costly. Filter media in MSDs are generally in the form of perforated pressure jackets. The higher the separating pressures used, the stronger (thicker) the filter media (pressure jacket) need to be in order to withstand those pressures. The thicker the pressure jacket, the longer the drainage perforations, the higher the flow resistance through the perforations. Thus, in order to achieve with high-pressure jackets (thick jackets) the same filter flow-through capacity as with low-pressure jackets (thin jackets), the number of perforations should be increased. However, increasing the number of perforations weakens the pressure jacket, once again reducing the pressure capacity of the filter unit. Another approach to overcome the higher flow resistance with longer perforations is to increase the diameter of the perforations. However, this will limit the capacity of the filter to retain small solids, or may lead to increased clogging problems. Thus, the acceptable pore size of the filter is limited by the size of the fibers and particles in the solids fraction. The clarity of the liquid fraction is limited solely by the pore size of the filter media and pores that are too large reduce the liquid/solid separation efficiency and potentially lead to plugging of downstream equipment.

Over time, filter media tend to plug with suspended solids, reducing their production rate. This is true especially at the high pressures required for cellulose pre-treatment. Thus, a backwash liquid flow is normally required to clear any blockage and restore the production rate. Once a filter becomes plugged, it takes high pressure to backwash the media. This is particularly problematic when working with filter media operating at pressures above 1000 psig with a process that is to be continuous to maximize the production rate and to obtain high cellulose pre-treatment process efficiency, for example.

Conventional single, twin, or triple screw extruders do not have the residence time necessary for low energy pre-treatment of biomass, and also do not have useful and efficient solid/fluid separating devices for the pre-treatment of biomass. U.S. Pat. No. 3,230,865 and U.S. Pat. No. 7,347,140 disclose screw presses with a perforated casing. Operating pressures of such a screw press are low, due to the low strength of the perforated casing. U.S. Pat. No. 5,515,776 discloses a worm press having drainage perforations in the press jacket, which increase in cross-sectional area in flow direction of the drained liquid. U.S. Pat. No. 7,357,074 is directed to a screw press with a conical dewatering housing with a plurality of perforations for the drainage of water from bulk solids compressed in the press. Again, a perforated casing or jacket is used. As will be readily understood, the higher the number of perforations in the housing, the lower the pressure resistance of the housing. Moreover, drilling perforations in a housing or press jacket is associated with serious challenges when very small apertures are desired for the separation of fine solids.

Published U.S. Application US 2012/0118517 discloses a solid/fluid separation module with high porosity for use in a high internal pressure press device for solid/fluid separation at elevated pressures. The filter module includes filter packs respectively made of a pair of plates that create a drainage system. A filter plate with cut through slots creates flow channels for the liquid to be removed and a backer plate creates a drainage passage for the liquid in the flow channels. Moreover, the backer plate provides the structural support for containing the internal pressure of the solids in the press during the squeezing action. The filter pore size is adjusted by the thickness of the filter plate and/or the opening width of the slots in the filter plate. However, material strength and manufacturing processes set practical limits to the lower end of the pore size spectrum. To minimize pore size, both the filter plate thickness and the drainage slot width must be minimized. However, practical limits on the process used for cutting the slots through the filter plate and on the thickness of the backer plate, due to the flow channel, unduly limit the lower end of the pore size spectrum. The thinner the filter plate the higher the chance of filter plate distortion during installation or use. Moreover, using two different plates increases manufacturing and assembly costs and increases the danger of assembly errors. Finally, the need for inclusion of the backer plate in the filter pack for structural integrity, especially pressure resistance, of the filter pack, significantly limits the maximum open area or filter porosity achievable per unit length of the filter pack, since the backer plates do not contribute to filter porosity. This significantly limits the throughput capacity of this type of filter unit. Thus, an improved solid/fluid separation device is desired.

### SUMMARY OF THE INVENTION

It is an object of the present invention to obviate or mitigate at least one disadvantage of previous solid/liquid separation devices and processes.

In order to improve solids/fluid separation, the invention provides a solid/fluid separation module for separating fluid from a solid/fluid mixture. Preferably, the module is for use in a screw press used for compressing the mass at pressures above 100 psig, preferably above 300 psig.

To achieve maximum solid/fluid separation efficiency, it is desirable to minimize filter pore size, while maximizing filter porosity and to operate at elevated separation pressures. Minimizing pore size is a challenge in conventional screw presses due to the need for cutting cylindrical passages into the solid filter jacket, or cutting filter slots through filter plates. These problems have now been addressed by the inventors in the separation module of the invention. The separation module includes a filter unit, wherein the pressure jacket is composed of a plurality of thin filter plates which are axially stacked and compressed for achievement of a pressure jacket, or barrel having the structural integrity required for elevated operating pressures. Filter pores are formed by simply recessing a filter passage into a surface of the filter plate. The filter passage extends from an inner edge of the filter plate at the core opening to an outer edge of the filter plate at the collection chamber and provides a fluid passage extending from the core opening directly to the collection chamber. This can be achieved much more easily than drilling holes in a pressure jacket or cutting filter slots through a filter plate. For example, the filter passage can be produced by etching the passage into the filter plate surface. By only recessing the filter passage into a surface of the filter plate, the overall integrity of the filter plate is affected much less than in filter plates having cut-through filter slots. This increased integrity significantly reduces the chances of warping or buckling of the filter plate during assembly into a filter block, or during use. Moreover, even though the filter passages extend from the inner edge to the outer edge of the filter plate, by forming the filter passages only in a surface of the filter plate, the need for any backer plates providing structural support is completely obviated. Using recessed passages also allows for the creation of much smaller filter pores by cutting only very narrow and shallow passages. For example, by cutting a filter passage of 0.01 inch width and 0.001 inch depth into the filter plate, a pore size of only 0.00001 square inch can be achieved (calculated as smallest depth of passage×smallest width of passage).

The solid/fluid separation module of the present description for separating a pressurized solid/fluid mixture includes a housing defining a pressurizable fluid collection chamber and a barrel section defining an axial core opening for containing the pressurized mass under pressure. The barrel section is mounted in the housing and includes a filter block, which forms at least an axial portion of the barrel. The filter block includes a plurality of stacked barrel plates, each having a flat front face, a flat rear face, an inner edge defining the core opening and extending from the front face to the rear face and an outer edge for contact with the collection chamber and extending from the front face to the rear face. The barrel plates are stacked in the filter unit for sealing engagement of the front and rear faces of adjacent barrel plates to form the filter block and seal the core opening from the fluid collection chamber. At least one of the barrel plates is constructed as a filter plate having a filter passage recessed into the front face, the filter passage extending from the inner edge to the outer edge for draining fluid in the pressurized solid/fluid mixture from the core opening to the collection chamber.

In a preferred embodiment, at least two adjacent barrel plates are each constructed as a filter plate. Preferably, the filter block forms the whole barrel section. In another preferred embodiment, a plurality of barrel plates are constructed as filter plates. Most preferably, each barrel plate is constructed as the filter plate. Moreover, each filter plate preferably includes multiple, most preferably a plurality, of the filter passages.

Each filter passage is formed as a recess in one of the front and rear faces of the filter plate. Although filter passages can be provided on each face of the filter plate, it is preferred for ease of manufacture and assembly to provide filter passages on only one face of the filter plate. Moreover, since maximum porosity of the filter block is achieved not only by increasing the number of filter passages but also by minimizing the filter plate thickness, providing filter passages on both sides of the filter plate may unacceptably weaken the structural integrity of the filter plate. In addition, filter plates having filter passages on both faces may need to be separated by flat backer plates to prevent cross-flow between filter passages placed face-to-face. This reduces the maximum number of filter plates per unit length of the separation module and makes assembly more difficult.

The filter passage recess can be produced, for example, by laser cutting or etching of the front face. One method for creating the filter passage is acid etching of the front face by using the well-known photolithography process. Surface roughness of the filter passage created by acid etching may be reduced by electro-polishing or by applying an anti-friction coating. The filter passage may be in the form of a recess or groove extending in a straight line from the inner edge to the outer edge in a substantially radial direction relative to the core opening. The filter passage may widen from the inner edge to the outer edge.

The separation of liquid from a mass including fibrous solids creates particular challenges for the filter construction, since the fibers may enter into and align in parallel in the filter passages, causing a tight plug in the passage which not only reduces or prevents the passage of liquid, but may be very difficult, if not impossible, to remove by backwashing. To address this problem, the filter passage may also include a sufficient directional deflection at any point along its length to block any straight line path through the passage. This may be achieved, for example, with a S-shaped, or Z-shaped curve in the longitudinal extent of the passage or by including a fork or split in the passage, for example, T-shaped, I-shaped, Y-shaped or U-shaped splits. It is the purpose of this directional deflection to impede the passage of a linear fiber. Short fibers, those having a length shorter than the width of the filter passage, may be able to pass the deflection, but are much less likely to accumulate in and block the passage. On the other hand, long fibers, those having a length greater than the width of the passage will most likely jam in the deflection. Depending on the overall length of the long fibers, they will jam at different depths and angles in the deflection. This results in a non-parallel, generally random orientation of the jammed fibers, similar to a random log jam in a tight turn of a river. This non-parallel orientation prevents a complete plugging of the passage at the deflection. At the same time, the fiber jam may create an additional filter layer, aiding in the retaining of superfine solids that would normally pass through the filter passage.

The separation module preferably includes a filter unit having a porosity, which means the ratio of the total pore area (sum of the area of all pores in the filter plates) to the total filter surface (area defined by the inner edge of all barrel plates in the filter unit) of 5% to 20%. Preferably, the module withstands operating pressures of 300 psig to 10,000 psig, at a filter porosity of 5 to 20%, more preferably 11 to 20%. Each filter plate preferably includes a plurality of filter passages with a pore size of 0.0005 to 0.00001 square inch.

In one exemplary embodiment, the filter unit includes filter pates with passages having a pore size of 0.00001 square inch for the separation of fine solids, a porosity of 5.7% and a pressure resistance of 2,500 psig. In another embodiment, the filter unit includes pores having a pore size of 0.0005 square inch and a porosity of 20% and a pressure resistance of 5,000 psig. In a further exemplary embodiment, the filter unit includes pores of a pore size of 0.00005 square inch and a porosity of 11.4%. In still another exemplary embodiment, the filter unit includes pores having a pore size of 0.00001 square inch and a porosity of 20%.

Pore size can be controlled by varying the width of the filter passage, the depth of the filter passage, or both. To maintain maximum filter plate integrity, the depth of the filter passage is preferably selected to be as small as possible, especially for very thin filter plates and the pore size is preferably controlled by varying the filter passage width. The width of the filter passages may vary from 0.1 inch to 0.01 inch and the depth of the filter passages may vary from 0.001 inch to 0.005 inch. The filter passages in a filter plate may all have the same pore size, or they may have different pore sizes, for example dependent on the pressure expected during operation at the core opening end (inner end) of each filter passage.

In one embodiment, the separation module is mountable to and incorporated in the barrel of a screw extruder press and the core opening of the filter block is sized to fittingly receive a portion of the extruder screw of the press. The extruder screw preferably has close tolerances to the core opening of the filter block for continually scraping the compressed solid/fluid mixture away from the filter surface formed by the inner edges of the barrel plates, while at the same time generating a significant separating pressure in the mixture. In the event that a small amount of fibers become trapped on the filter surface, close tolerances will improve the chances of the trapped fibers being sheared by the extruder elements into smaller pieces ultimately passing through the filter and out with the liquid stream as very fine particles. This provides a solid/fluid separation device, which allows for the separation of solids from fluid/liquid portions of a solid/fluid mixture in a high pressure and temperature environment.

In another embodiment, the separation module is mountable to the barrel of a twin screw extruder press and the core opening is sized to fittingly receive a portion of the intermeshing extruder screws. In a filter block variant for use in a barrel of a twin screw extruder, the pores sizes of the plates in the filter block are preferably varied according to the pressure variations within the barrel and/or about the twin screws. During operation of a twin screw extruder, barrel pressures vary over the cross-section of the barrel. Pressures are highest in the vicinity of the intermeshing zone. Thus, filter plates for use in a twin screw extruder can have filter passages of reduced pore size in the vicinity of the intermeshing zone. The separation module can be used with twin screws of constant or tapering cross-section.

In another aspect, the collection chamber has a liquid outlet and a gas outlet for separately draining liquids and gases from the collection chamber.

In one embodiment, each of the barrel plates has a pair of opposite mounting tabs for alignment and interconnection of the plates in a stacked configuration. Each mounting tab may have an opening in the form of a hole or slot for receiving a fastening bolt, for alignment and clamping together of the stack of barrel plates into the filter block portion of the barrel. Alternatively, the opening for the fastening bolt is omitted and the housing includes inwardly projecting ridges for aligning the tabs and preventing rotation of the barrel plates relative to the core opening, the clamping together of the stack of barrel plates being achieved in that embodiment by a pair of end plates clamped together by bolts external to the filter plates, or the housing.

Other aspects and features of the present disclosure will become apparent to those ordinarily skilled in the art upon review of the following description of specific exemplary embodiments in conjunction with the accompanying figures.

### BRIEF DESCRIPTION OF THE DRAWINGS

For a better understanding of the exemplary embodiments described herein and to show more clearly how they may be carried into effect, reference will now be made, by way of example only, to the accompanying drawings which show the exemplary embodiments and in which:

FIG. 1 is a partially schematic side elevational view of an exemplary solid/fluid separating apparatus including separation modules in accordance with the invention;

FIG. 2 is a vertical sectional view of an exemplary apparatus as shown in of FIG. 1, but including only one schematically illustrated solid/liquid separation module, for reasons of simplicity;

FIG. 3 schematically illustrates an embodiment of a solid/fluid separation module in exploded view;

FIG. 4A shows a schematic illustration of a barrel plate and a right handed filter plate of the separation module, the filter plate having multiple radially extending filter passages;

FIG. 4B shows a schematic illustration of a barrel plate and a left handed filter plate of the separation module, the filter plate having multiple radially extending filter passages;

FIG. 5 is an isometric view of a pair of filter plates in accordance with FIG. 4A, which are stacked front to back;

FIG. 6 is a cross-sectional view of the pair of stacked filter plates of FIG. 5, taken along line 6-6;

FIG. 7 is a schematic illustration of a filter plate similar to the one of FIG. 4A, but having larger number of filter passages of comparatively smaller pore size;

FIG. 8 shows an enlarged detail view of the filter plate of FIG. 7;

FIG. 9 shows a schematic illustration of a filter plate similar to the one of FIG. 4A, but having filter passages of different pore sizes;

FIG. 10 shows a schematic illustration of a variant filter plate including a directional deflection in each filter passage, the deflection being in the form of a U-shaped split in the filter passage adjacent the inner edge of the filter plate;

FIG. 11 illustrates an enlargement of the portion labeled FIG. 11 in the filter plate of FIG. 10;

FIG. 12 schematically illustrates a random logjam type arrangement of fibers at the deflection of FIG. 11; and

FIGS. 13A to 13E schematically illustrate different exemplary directional deflection shapes.

### DETAILED DESCRIPTION OF THE PREFERRED EMBODIMENTS

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various exemplary embodiments described herein.

The illustrated exemplary extruder unit of the invention includes a twin screw assembly having parallel or non-parallel screws with the flighting of the screws intercalated or intermeshed at least along a part of the length of the extruder barrel to define a close clearance between the screws and the screws and the barrel. Screw extruders with more than two extruder screws can also be used. Cylindrical or tapered (conical) screws can be used. The close clearance creates areas with increased shear. These areas create high pressure zones within the barrel which propel a solid/fluid mixture forwardly, while the mixture is kneaded and sheared. A specialized fluid separation unit is also provided, which allows fluids to be efficiently extracted from the extruded mixture.

The inventors have developed a solid/fluid separation device for use with a screw press conveyor, such as a twin screw extruder, which device can handle elevated pressures (up to 20,000 psig) and surprisingly was able to generate solids levels from 50-90% well beyond that of commercially available or laboratory devices, when combined with a twin screw extruder press. In addition, the liquid portion extracted with the separation device of the invention contained little suspended solids, due to the comparatively very small pore size of the device, which provides additional benefit. The combination of a high pressure solid/fluid separation unit with a twin screw extruder press resulted in a solid/fluid separation device able to develop virtually dry cake, which was completely unachievable previously without any drying steps. A twin screw extruder can be used to process the mixture in a thin layer at pressures far exceeding 300 psi while at the same time allowing trapped and bound liquid and water a path to migrate out of the solids and out of the apparatus through the novel solid/fluid separation device of this disclosure.

With a device in accordance with the invention including a twin screw extruder incorporating a separation module in accordance with the invention, one can apply significant shear forces/stresses to a mixture containing fluids, including liquids, and solids, including fibrous solids, which forces are applied in a thin cake within a structurally very strong solid/fluid separation module having a very fine filtering filter unit (strength of the filtering unit of up to 20,000 psi, with pores sizes down to 25 mircrons at temperatures up to 500 C). This at the same time allows the freeing up of liquid to migrate out through the fine filtering filter unit. Thus, it is expected that the this filter unit when used within a twin screw extruder press will provide benefits to any process requiring solid/fluid separation at solids contents above 50%.

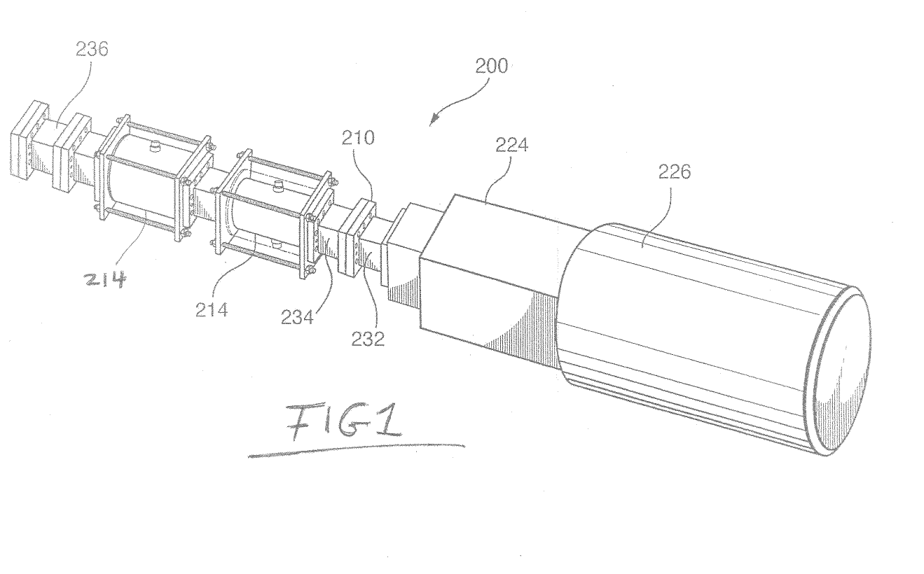

Turning now to the drawings, FIG. 1 schematically illustrates an exemplary solid/fluid separating apparatus 200 in accordance with the invention. The apparatus includes a twin screw extruder 210 with barrel modules 232, 234, 236 and separation modules 214, which extruder 210 is driven by a motor 226 through an intermediate gear box drive 224, both the motor and gear box being conventional components.

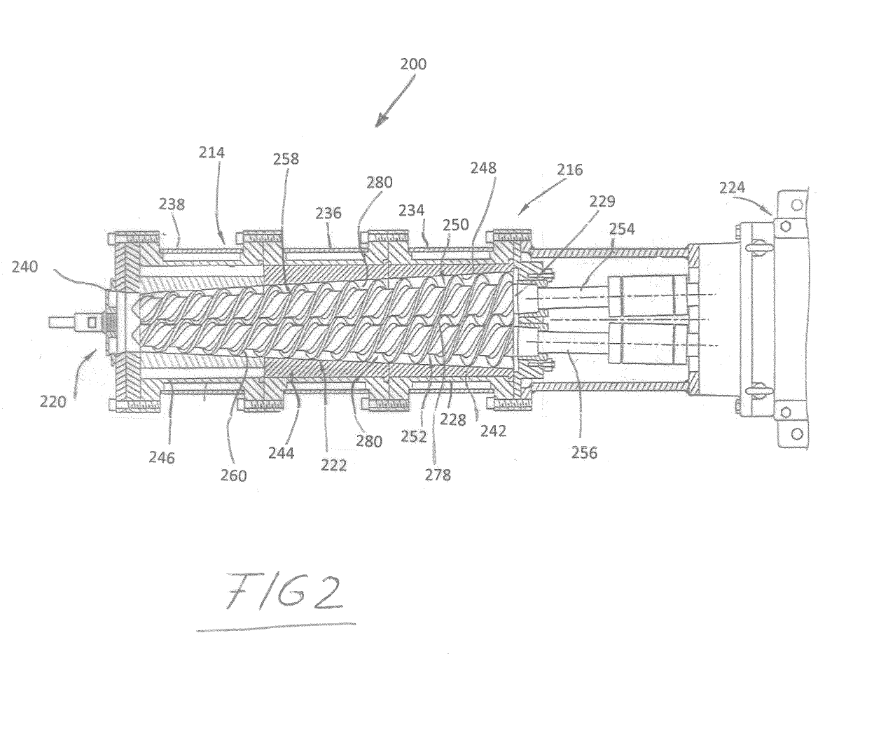

A vertical cross-section through a simplified exemplary embodiment of the apparatus shown in FIG. 1, including only a single separation module 214, is shown in FIG. 2. The exemplary apparatus 200 broadly includes a sectionalized barrel 216 presenting an inlet 218 and an outlet 219219, with a conventional twin screw assembly 222 within the barrel 216. The assembly 222 is coupled via the gear box drive 224 to the motor 226. The barrel 216, in the simplified exemplary embodiment illustrated here, is made up of two end-to-end interconnected tubular barrel modules 228, 230, and a separation module 214. Each barrel module is provided with an external jacket 234, 236. The separation module 214 includes an external housing 238. It will be observed that the first module 228 includes an inlet 229, while the separation module 214 is attached to a die 240. The die includes a central opening, the width of which is selected to produce the desired back pressure in the barrel 216 and the separation module 214. The pressure in the barrel 216 and the separation module 214 can also be controlled by the fit between the screws 250,252 and the barrel 216 and the rotational speed of the motor 226 (see FIG. 1) and, thus, the screws 250, 252. Each barrel unit also includes an internal sleeve 242, 244 which sleeves cooperatively define a tapered, continuous screw assembly-receiving core opening 128 within the barrel. This core opening 128 has a generally “figure eight” shape in order to accommodate the screw assembly 222. As illustrated, the core opening 128 is widest at the rear end of module 228 and progressively and uniformly tapers to the end of the apparatus at the outlet 219 of the barrel 216.

The screw assembly 222 illustrated includes first and second elongated screws 250, 252 which are in side-by-side relationship and include respectively an elongated central shaft 254, 256 as well as outwardly extending helical flightings 258, 260. In the illustrated screws, the shafts 254, 256 each have an outer surface which is progressively and uniformly tapered through a first taper angle from inlet 229 to proximal the outlet 219. The flightings 258, 260 extend essentially the full length of the shafts 252, 254 and proceed from a rear end adjacent the inlet 229 in a continuous fashion to a forward point at the outlet 219. The flightings 258, 260 of the respective screws 250, 252 are intercalated, or intermeshed, creating a plurality of close-clearance kneading zones 278 between the screws 250, 252. The spacing of the flightings 258, 260 from the wall of the screw receiving opening 248 may be selected to be similar to the respective spacing of the screws 250, 252 in the kneading zones, in order to achieve a continuous kneading all around the screws and create only limited passageways 280 for the backflow of the extruded mixture.

During operation, the extrudable solid/fluid mixture to be separated is passed into and through the extruder barrel 216. The screw assembly 222 is rotated so as to co-rotate the screws 250, 252 (generally in the same direction), usually at a speed of from about 20-1,200 rpm. Pressures within the extruder are usually at a maximum just adjacent the outlet 220, and may range from about 100-20,000 psig, or from about 300-10,000 psig. In general, the higher the speed of rotation of the screws, 250, 252, the higher the pressure generated within the extruder. Temperatures within the extruder may range from about 40-500° C. Extrusion conditions are created within the device 200 so that the product emerging from the extruder barrel usually has a higher solids content than the extrudable mixture fed into the extruder. During passage of the extrudable mixture through the barrel 216, the screw assembly 222 acts on the mixture to create, together with the endmost die 240 (or other backpressure generating structures), the desired pressure for separation. The specific configuration of the screws 250, 252 as described above generates separating conditions not heretofore found with conventional screw presses. That is, as the extrudable mixture is advanced along the length of the co-rotating screws 250, 252, it continually encounters the kneading zones 278 which generate relatively high localized pressures serving to push or “pump” the material forwardly. At the same time, the extrudable mixture is kneaded within the kneading zones 278 as the screws rotate. Backflow of material may be allowed through the passageways 280, or the size of the passageways 280 may be adjusted to also generate one or more kneading zones. The result is an intense mixing/shearing and potentially cooking action within the barrel 216. Furthermore, it has been found that a wide variety of extrudable solid/fluid mixtures may be separated using the equipment of the invention; simply by changing the rotational speed of the screw assembly 222 and, as necessary, temperature conditions within the barrel, which means merely by changing the operational characteristics of the apparatus. This degree of flexibility and versatility is uncommon in the filtration art.

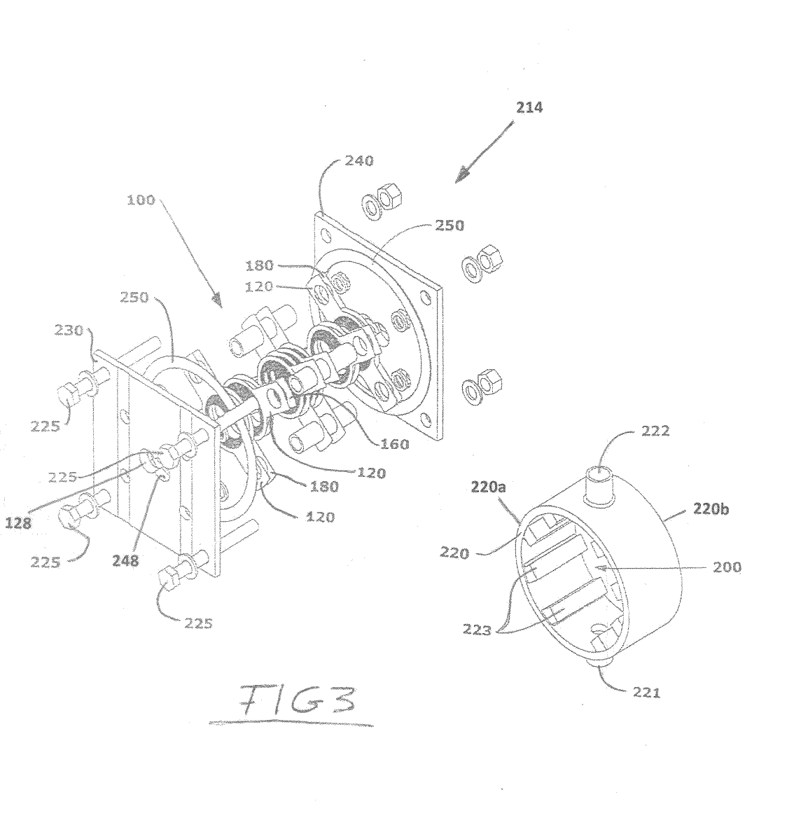

The basic construction of a separation module 214 of the invention is shown in FIG. 3. The separation module 214 in the apparatus of FIG. 2 includes a housing or pressure jacket 220, defining a collection chamber 200, a barrel 248 defining an axial core opening 128, and including a filter unit 100 made of a number of stacked barrel plates 120. At least one of the barrel plates is constructed as a filter plate 160, 180. The collection chamber 200, which is defined by the pressure jacket or housing 220 and intake and output end plates 230 and 240, is capable of withstanding the highest pressure of any component and is used to separate the filtered out fluids into gases and liquids. Liquid can be drained from the collection chamber 200 through a liquid drain 221, preferably located at the lowest point on the pressure jacket 220. The pressure jacket 220 further includes a plurality of alignment ridges 223 extending parallel to a longitudinal axis of the jacket on the inside of the jacket, for alignment of the barrel and/or filter plates within the collection chamber 200, as will be discussed in more detail below. Gas accumulated in the collection chamber 200 can be exhausted from the collection chamber through a gas drain 222, preferably located at the highest point on the pressure jacket 220. The high pressure collection chamber 200 is sealed by way of circular seals 250 positioned between axial ends 220a, 220b of the pressure jacket 220 and the end plates 230, 240. This high pressure/high temperature capability allows for washing of the extrudable mixture, for example a biomass, such as a lignocellulosic biomass. The extrudable mixture may be washed with fluids such as ammonia, CO2 and water which are normally in the gaseous state at process operating temperatures of 50 to 250° C. The separation module 214 is held together by assembly bolts 225 located outside the pressure jacket 220 for pulling the end plates 230, 240 together and clamping the pressure jacket 220 and circular seals 250 therebetween. Additional filter unit clamping bolts (not shown) can also be used to clamp together the barrel plates 120 and filter plates 160, 180, housed in the housing 220, which clamping bolts extend through bores 231, 241 in the end plates 230, 240 respectively and provide for additional clamping together of the separation module 200. In order to minimize the number of penetration points in the separation module 200, which need to be reliably sealed for maintaining a pressure in the collection chamber 200, the filter unit fastening bolts can be omitted and all clamping together of the pieces of the separation module 200 achieved by external fastening structures, such as the assembly bolts 225, located outside the pressure jacket 220. Depending on the pressures used, some gases can be separated right in the collection chamber 200, or a separate flash vessel can be utilized to optimize the overall efficiency of the process.

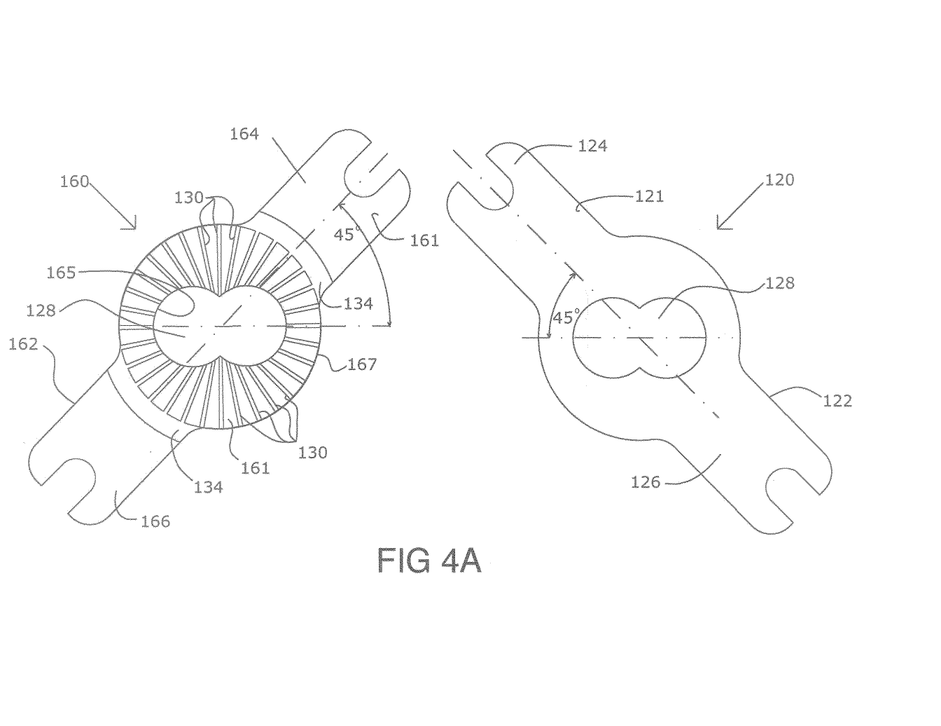

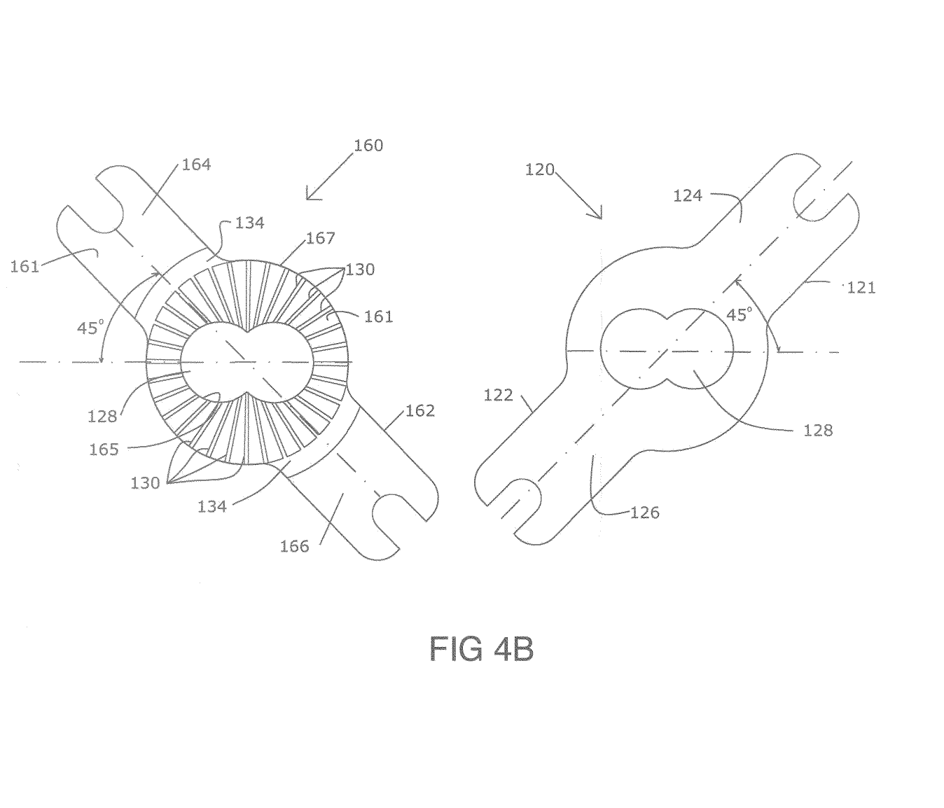

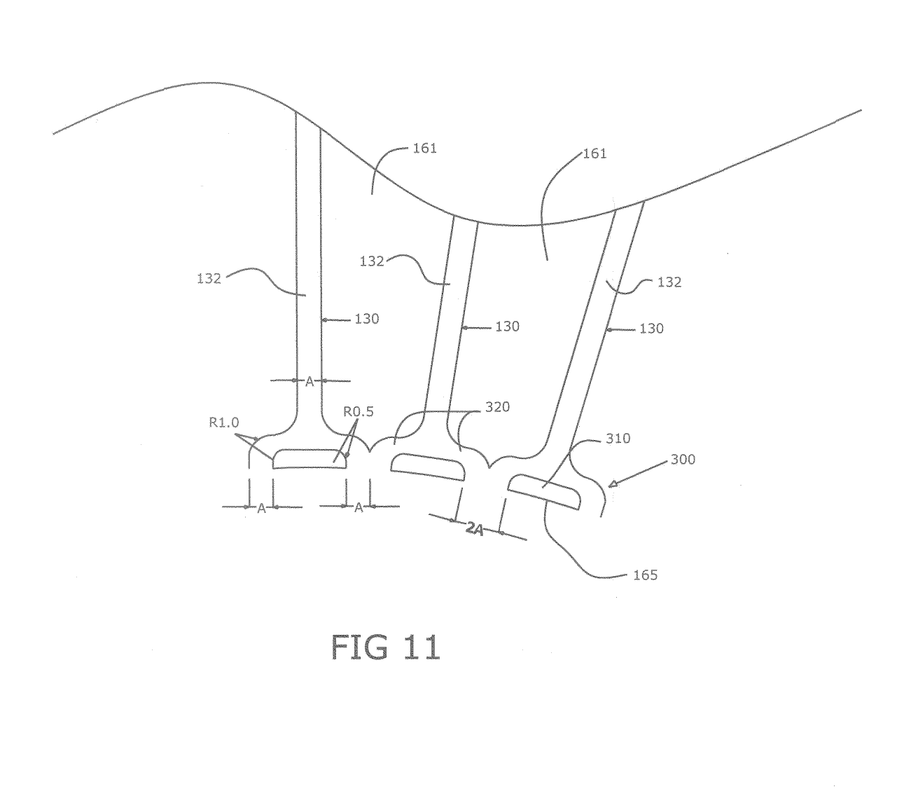

The filter unit 100 in the illustrated exemplary embodiment includes several plate stacks assembled from the barrel plates 120 and filter plates 160, 180, which will be discussed in more detail below. The filter unit can include alternating barrel plates 120 which have flat front and rear surfaces and filter plates 160, 180 which have filtering passages (see FIGS. 4-13) in the front surface. The filter unit can also include one or more pairs of filter plates 160, 180 stacked directly one behind the other. In one preferred embodiment, all barrel plates in the filter unit are constructed as filter plates 160, 180 so that the stacked filter plates 160, 180 completely fill the spacing between the end plates 230, 240, in order to maximize the porosity and filtering capacity of the filter unit. The filter and barrel plates (160, 180 and 120) as well as the end plates 230, 240 all define the barrel 248 and have the throughgoing core opening 128 for receiving the pressurized extrudable mixture (not shown). The core opening 128 is sealed from the collection chamber 200 by the clamped plates 120, 160, 180. The core opening 128 is identical in size and shape to the screw assembly receiving barrel 248 shown in FIG. 2. The separation module 214 replaces a section of the barrel 216 and the stacked barrel plates 120 and/or filter plates 160, 180 form a solid filter block, when clamped between the end plates 230, 240, which filter block forms part of the barrel. For maximum porosity, the filter unit preferably includes only barrel plates constructed as filter plates 160, 180, which filter plates are arranged behind the cover plate 230 in a stack of filter plates, whereby the back face 163 of each filter plate 160, 180 functions as a cover for the front face 161 of the filter plate 160, 180 stacked respectively behind. By using only filter plates 160, 180 with no intermediate flat barrel plates 120, the filter capacity of the filter unit 100 can be maximized.

In a continuous test, using a 1 inch, dual screw extruder, and a separation module including 3 plate stacks of 1 inch length, each including 200 stacked filter plates 160, 180 of 0.005 inch thickness and an overall open area of 0.864 square inches, a dry matter content of 72% was achieved at barrel pressures of about 600 psig. On a continuous basis, 100 g of biomass (corncobs, poplar wood) containing 40 g of solids and 60 g of water were squeezed out in the separation module 100 using 600 psig internal force at a temperature of 100 C to obtain a dry biomass discharge (solids portion of the liquid/solid biomass) containing 39 g of suspended solids and 15 g of water. The filtrate obtained contained about 95 g of water. The filtrate was relatively clean containing only a small amount (about 1 g) of suspended solids with a mean particle size equal to the pore size of the filter passages.

FIG. 4 schematically illustrates a barrel plate 120 having a circular middle section 122 attached to a first support tab 124 and a second support tab 126. The circular middle section 122 has a figure eight shaped core opening 128 for fittingly receiving the press screws of a twin screw extruder press. The barrel plate 120 has a front face 121 and a back face 123, an inner edge 125 extending between the front and back faces 121, 123 and defining the core opening 128 and an outer edge 127 in contact with the collection chamber 200. When multiple barrel plates 120 are stacked and clamped together for sealing engagement of the front and back faces 121, 123 of adjacent plates 120, the circular middle sections 122 form a barrel section.

One or more of the barrel plates 120 may be modified to form a right handed filter plate 160 as illustrated in FIG. 4A or a left handed filter plate 180 as illustrated in FIG. 4B. The basic construction of the filter plates 160, 180 is the same as that of the barrel plate, the barrel plate 120 and filter plates 160, 180 having a circular middle section 162 attached to a first support tab 164 and a second support tab 166. The circular middle section 162 has the figure eight shaped core opening 128 for fittingly receiving the press screws of a twin screw press. The barrel plate 120 and filter plates 160, 180 have a front face 161 and a back face 163, an inner edge 165 extending between the front and back faces 161, 163 and defining the core opening 128 and an outer edge 167 in contact with the collection chamber 200. However, in the filter plates 160, 180, the front face 161 includes at least one filter passage 130. In the embodiment illustrated in FIGS. 4A and 4B, the core opening 128 is surrounded on the front face 161 by a plurality of filter passages 130. The structural feature which allows filter plates 160 to be used in a right handed orientation and filter plates 180 to be used in a left handed orientation is the orientation of the mounting tabs 164, 166. When viewed from the front surface 161, the mounting tabs 164, 166 extend at a 45 degree angle relative to the transverse axis of the core opening 128. The orientation of the mounting tabs 164, 166 in the right handed filter plates 160 is therefore 90 degrees shifted from the one of the mounting tabs 164, 166 in the left handed filter plates 180. Of course, the barrel plate 120 includes the same principal orientational features as the filter plates 160, 180, the mounting tabs 124, 126 of the barrel plate 120 extending at a 45 degree angle relative to the transverse axis of the core opening 128. However, since the front and back surfaces 161, 163 of the barrel plate 120 are identical, the barrel plate 120 can be flipped over and used in either the right or left handed orientation.

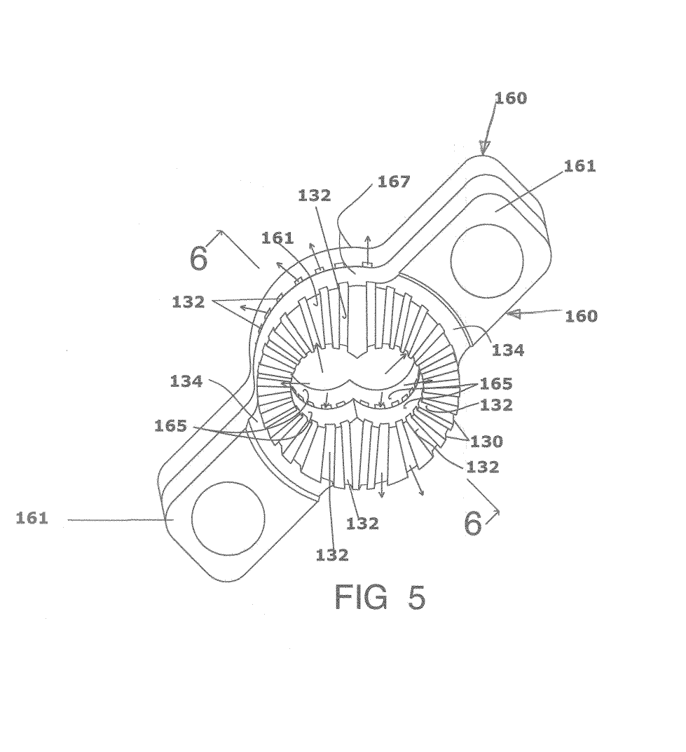

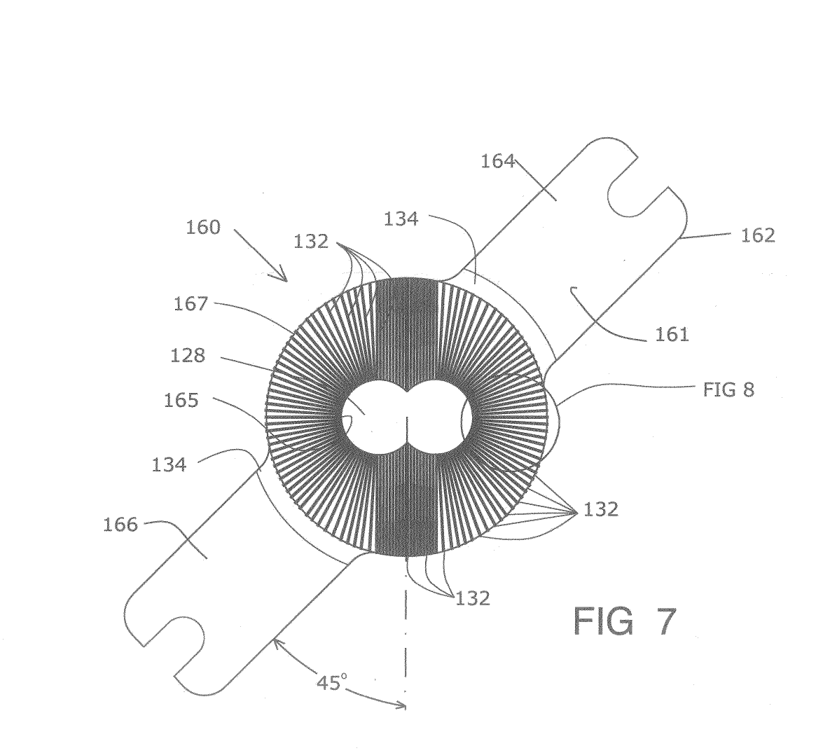

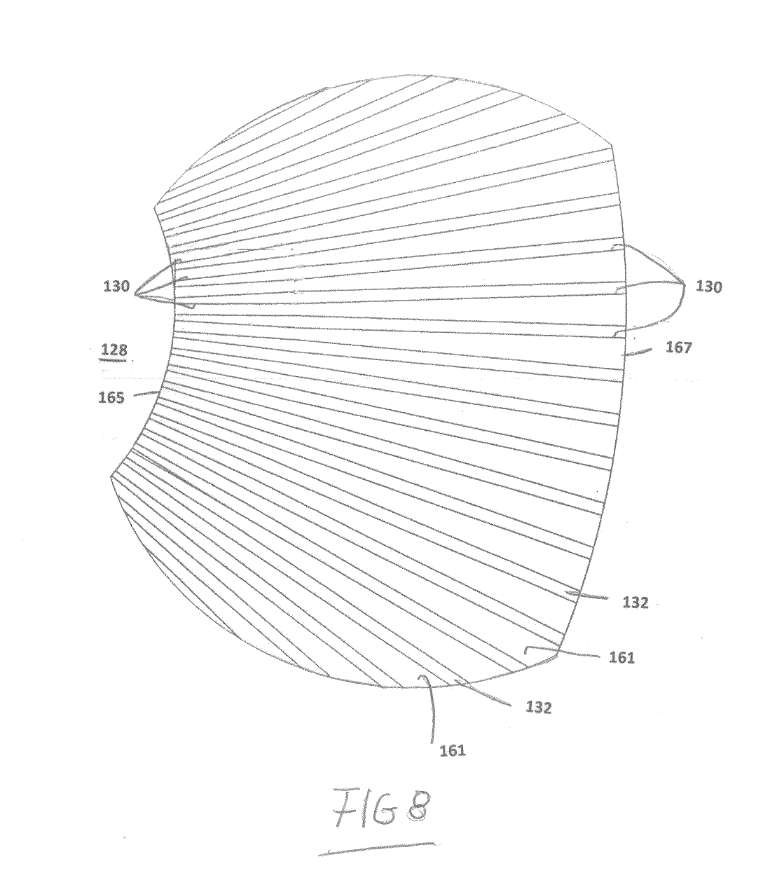

The detailed construction of the filter plates 160, 180 will now be discussed in relation to the right handed filter plate 160 shown in FIG. 4A, the structural features of the left handed filter plate 180 in FIG. 4B being identical, except for the orientation of the mounting tabs 164, 166. The filter plate 160 of FIG. 4A includes a number of coarse filter passages 130 for ease of illustration. A preferred filter plate 160 with a much larger number of finer filter passages 130 will be discussed below with reference to FIGS. 7 and 8. To achieve maximum solid/fluid separation efficiency, it is desirable to minimize filter pore size, while maximizing filter porosity. Minimizing pore size is a challenge in conventional screw presses due to the need for cutting cylindrical passages into the filter jacket. This problem is addressed with a filter unit in accordance with the invention, wherein filter pores are formed by simply cutting a recess 132 into the front face 161 of a thin filter plate 160 to form a filter passage 130. The recess 132 is cut to a depth, which is only a fraction of the filter plate thickness, to preserve the structural integrity of the plate and prevent warping or buckling of the plate during installation or operation. Preferably, the recess 132 has a depth, which is at most ⅓ of the plate thickness, more preferably ⅕ of the plate thickness, most preferably at most 1/10 of the plate thickness. Very small filter pores can be achieved with filter plates 160 in accordance with the invention by using very thin filter plates and very shallow recesses 132 as shown in FIGS. 4 and 5. For example, by cutting a filter recess or groove of 0.05 inch width and 0.001 inch depth into the filter plate, a pore size of only 0.00005 square inch can be achieved. For even finer filtering, filter recesses of 0.01 inch width can be used. Exemplary filter plate thickness/recess depth/recess width combinations are listed in Table I.

TABLE I

| | Plate Thickness | Recess depth | Recess Width |
|---|---|---|---|
| EXAMPLE | (inches) | (inches) | (inches) |
| 1 | 0.005 | 0.001 | 0.010 |
| 2 | 0.020 | 0.001 | 0.040 |
| 3 | 0.020 | 0.005 | 0.040 |

Cutting of the recess 132 into the front face 161 of the filter plate 160 can be achieved by any conventional process, such as cutting or etching, for example laser cutting or acid etching. In one embodiment, the filter plate 160 is 316 Stainless Steel and the recess 132 is cut by acid etching. A conventional photo lithography process can be used to define on the front face 161 the recess pattern to be cut. Each filter plate 160 includes one or more filter passages 130 which extend from the inner edge 165 to the outer edge 167 for providing a fluid drainage passage from the core opening 128 to the collection chamber 200, when the filter plate 160 is clamped with barrel plates 120 or other filter plates 160, 180 into the filter block in the filter unit 100. As shown in the Figures, each filter plate 160 preferably includes a plurality of filter passages 130, preferably the maximum number of filter passages 130 that can be arranged on the front face 161 with a photo etching process without undue tolerances in the pore size caused by undercutting of the acid under the photo lacquer from one recess into the other, especially at the inner edge 165.

The surface produced using a laser cutting or acid etching process is generally uneven. This results in the filter passages having a base of significant surface roughness, which may interfere with the fluid flow through the passage and may increase the propensity of suspended particles or fibers in the filtrate to become trapped in the passage, possibly leading to a complete blockage. To counteract this effect, an anti-friction coating can be applied to the filter passages which will reduce the potential of particles in the filtrate settling in the passage. The anti-friction coating can be sprayed into the passages using an ink jet printing process, or the complete surface of the filter plate can be oversprayed with the coating and subsequently polished to remove any coating outside the filter passages. Depending on the type of coating used, the polishing step can be omitted. The filter passages can also be electro-polished instead of, or in addition to, the application of the anti-friction coating. If electro-polishing and anti-friction coating are used in combination, the filter passages are polished prior to application of the coating. Photo-lithography and electro-polishing processes applicable for the cutting of the recesses 132 forming the filter passages 130 are well known and need not be described in detail herein.

Each right handed filter plate 160 is stacked with its front face 161 against either a barrel plate 120, the back face 163 of a like filter plate 160, or the back face 163 of a left handed filter plate 180, as shown in FIG. 3. It is apparent from FIG. 3 that the filter plates are installed as right handed plates 160 or left handed plates 180 in the filter unit 100. The orientation of the filter plates as left and right hand filter plates is thereby used to create a 90 degree shift in the holding pattern of the plates and to provide a means for liquid to drain to the bottom of the collection chamber 200 and gases to flow to the top of the collection chamber if the particular mass filtered by the filter unit 100 requires liquid/gas separation. The number of consecutive right hand plates 160 (or conversely left hand plates 180) with or without intermediate barrel plates 120 is advantageously equal to at least 0.25″ thick but can be as much as 1″ thick depending on the overall number of plates in the module.

As can be seen in FIG. 3, the barrel plate mounting tabs 124, 126 and the filter plate mounting tabs 164, 166 are all shaped to be fittingly received between pairs of alignment ridges 223 mounted on an inner wall of the pressure jacket 220.

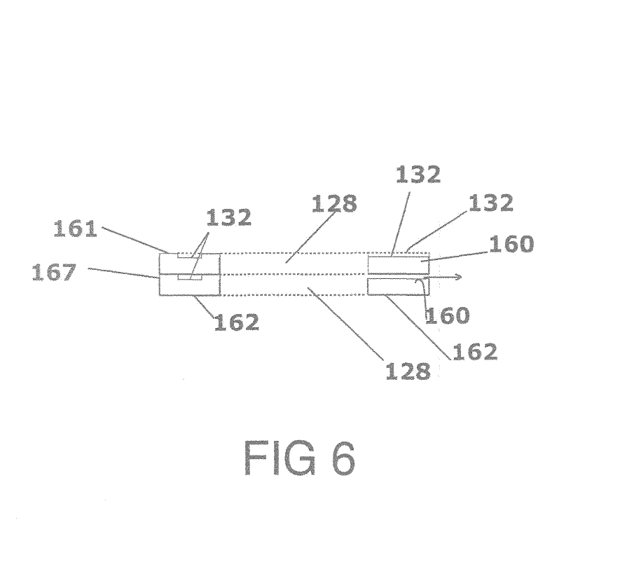

FIGS. 6 and 7 illustrate the most basic filter pack in accordance with the invention made only of filter plates 160. A pair of filter plates 160 are stacked one behind the other with the front face 161 of one filer plate 160 engaging the rear face 163 of the other filter plate. Fluids (liquid and/or gas) entrained in the extruded solid/fluid mixture (not illustrated) fed through the core opening 128 are forced by the separating pressure present to flow (see arrows) at the inner edge 165 into the filter passages 130 formed by the recesses 132 in the front faces 161. At the outer edge 167, the fluid exits the filter passage 130 into the collection chamber (see FIG. 3). As such, the filter plate 160 can filter out liquid and very small particles which travel through the filter passages 132 in a direction transverse to the flow of the extruded mixture through the figure eight shaped core opening 128. In order to allow drainage from the outer ends of filter passages 130 that end in one of the mounting tabs 164, 166, an arcuate recess 134 is cut into the front face 161 across the base of the mounting tab, which recess 134 can be cut in the same manner and to the same depth as the filter passages 130, but can have a significantly larger width.

Overall, with the higher pressure capability, either more liquid can be squeezed from the extrudable mixture or, for the same material dryness, a higher production rate can be achieved per unit filtration area. The quality of filtration (solids capture) can be controlled depending on plate configurations and thicknesses. The filtration/pressure rating/capital cost can be optimized depending on the filtration requirements of the particular biomass. The plate configurations can be installed in an extruder (single, twin or triple screws) to develop high pressure, high throughput, continuous separation. The solid/fluid separation module is somewhat self cleaning (for twin and triple screws) due to the wiping nature of the screws and the cross axial flow pattern. The filtration area is flexible depending on process requirements as the length of the plate pack can be easily custom fitted for the particular requirements. The module may be used to wash solids in a co-current or counter-current configuration in single or multiple stages in one machine reducing capital cost and energy requirements. The pressure of the liquid filtrate can be controlled from vacuum conditions to even higher than the filter block internal pressure (2,000 to 3,000 psig) if required. This provides great process flexibility for further separations in the liquid stream (for example super critical CO₂ under high pressure, ammonia liquid used for washing under high pressure, or release of Volatile Organic Compounds and ammonia gases in the collection chamber using vacuum). The high backpressure capability (higher than internal filter block pressure) can be used to back flush the filter during operation in case of plugging or scaling of the filter, thereby minimizing down time.

Due to the elevated porosity and pressure resistance of the separation module in accordance with the invention, a dry matter content in the dry portion discharge of up to 90% is possible, while at the same time a relatively clean liquid portion is achieved, due to the small pore size, with suspended solids being as low as 1%. It will be readily understood that the solid/fluid separation module in accordance with the invention can be used in many different applications to separate solid/fluid portions of a material.

In one exemplary embodiment, the filter unit 100 includes filter pores having a pore size of 0.00005 square inch for the separation of fine solids, a porosity of 5.7% and a pressure resistance of 2,500 psig. In another exemplary embodiment, the filter unit 100 includes filter pores having a pore size of 0.005 square inch and a porosity of 20% and a pressure resistance of 5,000 psig. In a further exemplary embodiment, the filter unit 100 includes filter pores of a pore size of 0.00005 square inch and a porosity of 11.4%. In still another exemplary embodiment, the filter unit 100 includes filter pores having a pore size of 0.005 square inch and a porosity of 20%.

### Filter Porosity

The size of the filter pores is the depth of the filter recess×the width of the slot at opening. In the filter plate of FIG. 4, the pore size is 0.001″ (depth of the recess)×0.010″ (width of the slot at the opening)=0.00001 square inch per pore. There are 144 pores per plate for a total pore area of =0.00144 square inch open area per plate.

In an experimental setup using a small, 1 inch diameter twin screw extruder, 600 of these filter plates 160, 180 were stacked exclusively with one another. Each plate was 0.0050″ thick, resulting in a total open area of the filter of 0.864 square inches. At this porosity, the stack of experimental plates was able to withstand a separation pressure of 2,500 psig. A 1″ thickness pack of plates 160 included 200 filter plates, each having an open area of 0.00144 square inch, which results in a total of 0.288 square inch of open area for the pack. That equals to more than a ¼″ diameter pipe, all achievable within a distance of only 1 inch of extruder length in the small 1″ diameter extruder used for the experimental setup. Alternating stacks of 200 right hand filter plates 160 and left handed filter plates 180 were used.

The porosity can be increased by decreasing the thickness of the filter plates, or of the barrel plates if any barrel plates are used. Reducing plate thickness by 50% will double the porosity of the filter unit. However, the strength of the filter unit will decrease whenever the plate thickness is decreased. This can be counteracted by increasing the overall diameter of the circular middle section of the plates, making the liquid flow path slightly longer but keeping the open area the same.

FIG. 7 schematically illustrates a filter plate 160 similar to that of FIG. 4, but having a much larger number of filter passages of smaller pore size. As can be seen from the enlarged detail view of FIG. 8, the filter passages 130 slightly increase in width from the inner edge 165 to the outer edge 167. FIGS. 7 and 8 illustrate one embodiment of the filter plate, wherein the filter recesses have a depth of 0.001 inches throughout and a width of 0.01 inches at the inner edge 165 and 0.02 inches at the outer edge 167. The overall number of filter passages 130 is 144 for this exemplary plate.

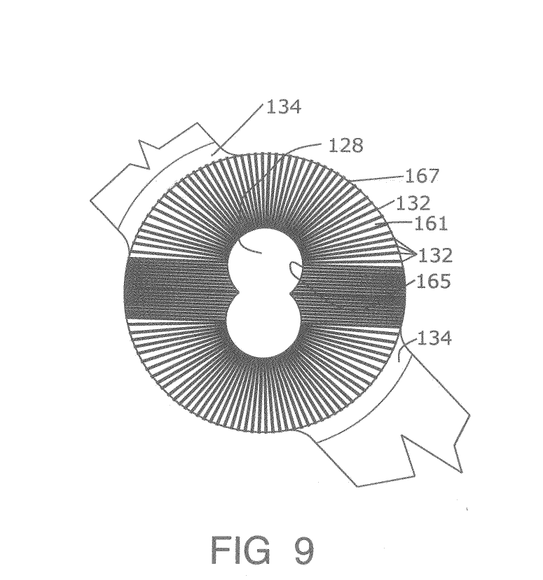

In a variant filter plate as shown in FIG. 9, the filter passages adjacent the intercalation or intermeshing area of the extruder screws are more tightly arranged and have a smaller pore size, in accordance with elevated barrel pressures expected in this region.

The use of filter plates 160, 180 for the manufacturing of the filter module allows for low cost production of the filter, since low cost production methods can be used for the manufacture of the filter plates. The filter recesses 132 in the filter plates 160, 180 can be laser cut, or etched. The type of material used for the manufacture of the filter unit can be adapted to different process conditions. For example, in low pH/corrosive applications materials like titanium, high nickel and molybdenum alloys can be used.

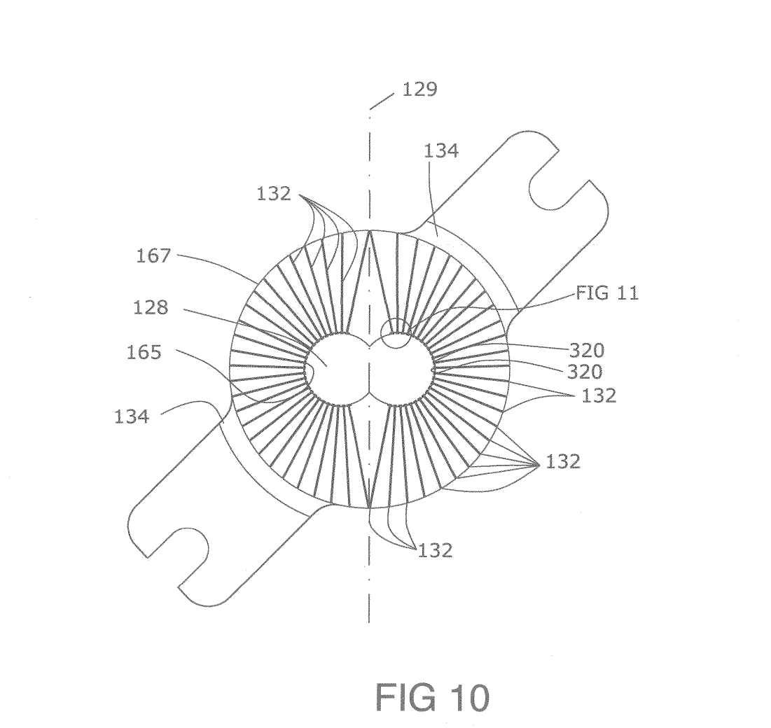

Each filter passage 130 is formed as a recess 132 in one of the front and rear faces 161, 163 of the filter plates 160, 180. Although filter passages 130 can be provided on each face of the filter plate 160, it is preferred for ease of manufacture and assembly to provide filter passages 130 on only one face of the filter plate. Moreover, since maximum porosity of the filter block is achieved not only by increasing the number of filter passages 130 but also by minimizing the filter plate thickness, providing filter passages 130 on both sides 161, 163 of the filter plate 160, 180 may unacceptably weaken the structural integrity of the filter plate. In addition, filter plates 160, 180 having filter passages on both faces (not illustrated) will need to be separated by flat barrel plates 120 functioning as backer plates to prevent cross-flow between any filter passages 130 placed face-to-face. This reduces the maximum number of filter plates 160, 180 per unit length of the separation module 214 and makes assembly more difficult. Cross-flow between filter passages in mutually facing double sided filter plates can also be avoided if the filter passages 130 are arranged in a symmetrical pattern on each side of the filter plate so that each filter passage 130 in one of a pair of mutually facing filter plates is aligned and completely overlaps one filter passage 130 in the other of the pair of mutually facing filter plates. This symmetrical pattern is achieved by placing the filter passages 130 in a mirror arrangement to each side of the vertical plane of symmetry 129 of the core opening, as shown, for example, in FIG. 10. Although the need for interposed flat barrel plates 120 (not shown in FIG. 10) is obviated with this design and assembly is facilitated, it is a disadvantage of this design that the resulting filter passages of the mutually facing filter plates have double the pore size, thereby reducing the retaining capacity of the separation module in terms of particle size. Thus, if the pore size is to be maintained, the flat barrel plates will have to be interposed nevertheless.

The filter recess 132 forming the filer passage 130 can be produced, for example, by laser cutting or acid etching of the front face 161. One method for creating the filter passage is acid etching of the front face 161 by using the well-known photo-lithography process. Surface roughness of the filter passage created by acid etching may be reduced by a known electro-polishing process or by the application of an anti-friction coating. The filter passage 130 may be in the form of a recess or groove 132 extending in a straight line from the inner edge 165 to the outer edge 167 in a substantially radial direction relative to the core opening 128. The filter passage 130 may widen from the inner edge 165 to the outer edge 167, as shown in FIG. 8.

The separation of liquid from an extrudable mixture including fibrous solids creates particular challenges for the filter construction. The fibers may enter into and align in parallel in the filter passages 130, causing a tight plug in the passage which not only reduces or prevents the passage of fluid, but may be very difficult, if not impossible, to remove by backwashing. This problem forms the basis of the variant embodiment of a filter plate 160, 180 in accordance with the invention as illustrated in FIGS. 10 to 13. To address the problem, the filter passages 130 may include a directional deflection 300, as illustrated in FIGS. 10 to 13, at any point along their length to block any straight line path through the passage. This may be achieved with providing a S-shaped, or Z-shaped curve in the longitudinal extent of the passage or by including a fork or split in the passage, for example, T-shaped, V-shaped, Y-shaped or U-shaped splits. An exemplary deflection in the form of a U-shaped split is shown in FIGS. 10 to 12. It is the purpose of the directional deflection 300 to impede a straight line passage through the filter passage 130, or a straight passage of a linear fiber. Thus, any directional deflection 300 in the filter passage 130 which is sufficient to block a straight line pass through the filter passage 130 can be used, irrespective of the shape of the deflection, or the location of the deflection along the longitudinal extent of the filter passage 130. In the embodiment illustrated in FIGS. 10 to 12, the deflection 300 is advantageously located at the end of the passage 130 at the inner edge 165. In the U-shaped deflection 300 illustrated in FIGS. 10 to 12, the filter passage 130 includes a recess 132 of a width of A, etched into the front surface 161 of the filter plate 160. The U-shaped split is created by branching the recess 132 into a pair of opposing branches 320 by curving the recess 132 in opposite directions at a radius equal to the width of the recess, in the illustrated embodiment 0.001 inches (1 micron). The branches 320 are then curved back to the original direction of the recess at the same radius, to create the U-shaped split. The portion of the front face 161 located between the inner edge 165 and the branches 320 creates a bumper 310 which blocks the straight line passage through the filter passage 130.

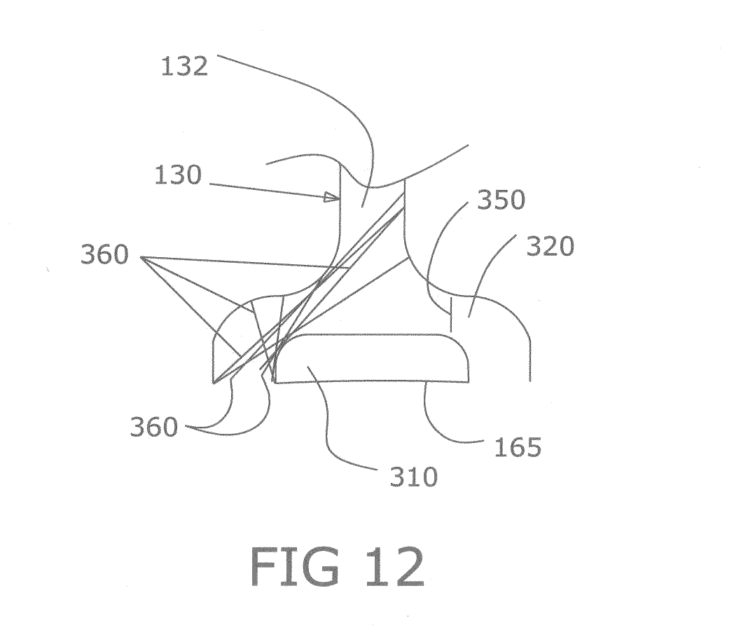

As illustrated in FIG. 12, short fibers 350, those having a length shorter than the width of the filter passage 130, may be able to pass the deflection 300, but are less likely to accumulate in and block the passage 130, since they are not long enough to jam in the passage. On the other hand, long fibers 360, those having a length greater than the width of the passage 130 will most likely jam in the deflection 300. Long fibers 360 that jam in the deflection 300, will jam at different depths and angles in the deflection 300, depending on the overall length of the long fibers 360. This results in a non-parallel, generally random orientation of the jammed fibers 360, similar to a random logjam in a tight turn of a river. This generally non-parallel orientation of the jammed fibers 360 prevents a complete plugging of the filter passage 130 at the deflection. At the same time, the fiber jam may create an additional filter layer, aiding in the retaining of superfine solids that would normally pass through the filter passage 130.

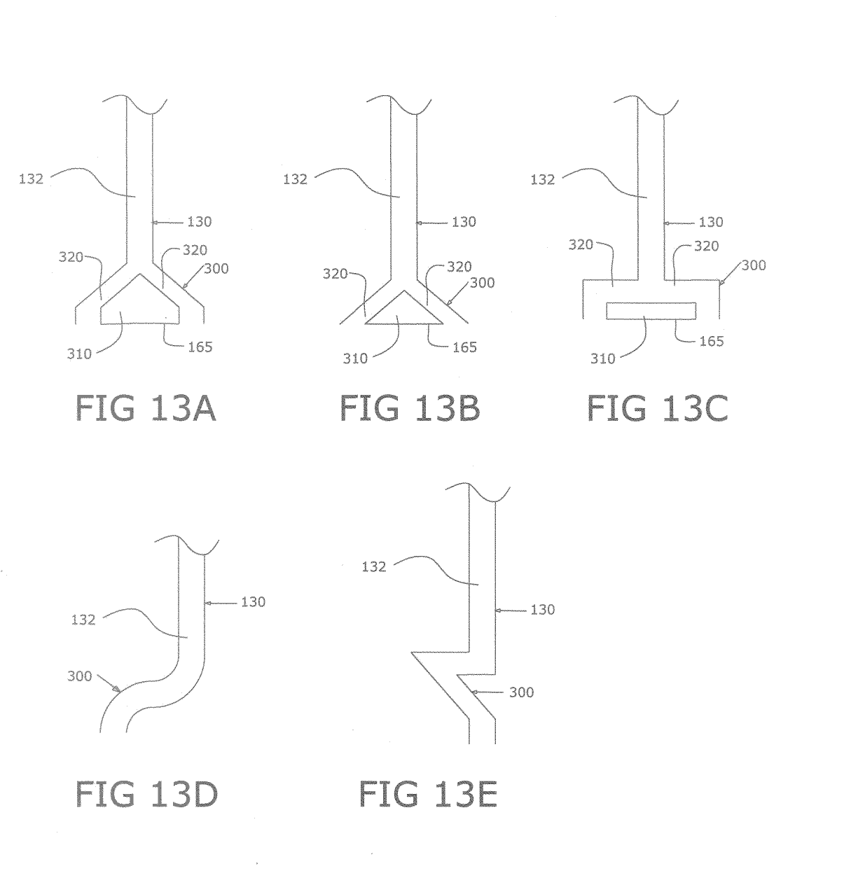

FIGS. 13A to 13E schematically illustrate other types of deflections in the filter passage 130, such as Y-shaped, V-shaped, T-shaped, S-shaped and Z-shaped deflections. As with the exemplary embodiments of FIGS. 1-9, the filtering passages 130 in the exemplary embodiments of FIGS. 10-13E may widen towards the outer edge 167, for example from the deflection 300 to the outer edge 167.

The inventors have developed a solid/fluid separation device, which separates solid and fluid portions of an extrudable mixture at elevated pressures. It is contemplated that the solid/fluid separation device can be used in many different applications to separate solid/fluid portions of a material. Further, as the solid/fluid separation device of the present invention can have a much smaller pore size than conventional filtration devices, it is expected to be less susceptible to clogging, thereby reducing the need for maintenance including back washing as is periodically required with conventional devices. Thus, the solid/fluid separation device of this disclosure can be used in a process with less downtime and less maintenance resulting in increased production capability and less cost, compared to conventional filtration devices.

In the solid/fluid separation device described, the screw elements that transfer the material internally in the separation device can have very close tolerances to the internal surface of the filter block and continually scrape the material away from the filter surface. In the event that a small amount of fibers became trapped on the surface of the filter, they will be sheared by the extruder elements into smaller pieces and ultimately pass through the filter and out with the liquid stream.

The total number of filter plates can vary depending on the extrudable mixture and controls the overall filter area. For the same solid/fluid separation conditions, more plates/more surface area is required for smaller pores. The size of the pores controls the amount of solids which pass to the fluid/liquid portion. Each extrudable mixture can have a need for a certain pore size to obtain a desired maximum solids capture (amount of suspended solids in liquid filtrate).

Although this disclosure has described and illustrated certain embodiments, it is also to be understood that the system, apparatus and method described is not restricted to these particular embodiments. Rather, it is understood that all embodiments, which are functional or mechanical equivalents of the specific embodiments and features that have been described and illustrated herein are included.

It will be understood that, although various features have been described with respect to one or another of the embodiments, the various features and embodiments may be combined or used in conjunction with other features and embodiments as described and illustrated herein.

What is claimed is:

1. A solid/fluid separation module for separating a pressurized solid/fluid mixture, comprising
a housing defining a pressurizable fluid collection chamber; and
a barrel defining an axial core opening for containing the solid/fluid mixture under pressure, the barrel including a filter block;
the filter block forming at least an axial portion of the barrel and consisting of a plurality of stacked barrel plates;
each barrel plate having a flat front face, a flat rear face, an inner edge defining the core opening and extending from the front face to the rear face, and an outer edge for contact with the collection chamber and extending from the front face to the rear face, the barrel plates being tightly stacked in the filter unit for sealing engagement of the front and rear faces of adjacent filter unit plates to seal the core opening from the fluid collection chamber; and
at least one of the barrel plates being constructed as a filter plate having a filter passage recessed into the front face, the filter passage extending from the inner edge to the outer edge for draining fluid in the pressurized solid/fluid mixture from the core opening to the collection chamber.

2. The separation module of claim 1, wherein at least two adjacent barrel plates are each constructed as the filter plate.

3. The separation module of claim 1, wherein the filter block forms the whole axial portion of the barrel.

4. The separation module of claim 1, wherein each barrel plate is constructed as the filter plate.

5. The separation module of claim 3, wherein each filter plate includes a plurality of the filter passages.

6. The separation module of claim 1, wherein the filter plate has a preselected pore size and the filter passage has an opening area at the inner edge corresponding to the preselected pore size.

7. The separation module of claim 5, wherein the filter block has a preselected filter pore size and a preselected porosity, each filter passage having an opening area at the inner edge corresponding to the preselected pore size and each filter plate having a plate porosity calculated from a total surface of the core opening, the preselected pore size and the number of filter passages, the filter block including a number of filter plates at least equal to the preselected porosity/plate porosity.

8. The separation module of claim 1, wherein the filter passage widens in a direction away from the inner edge.

9. The separation module of claim 1, wherein the collection chamber has a pressure jacket for housing the filter unit, the pressure jacked being sealably closed at an input end by an input end plate and at an outlet end by an outlet end plate, the filter block being sandwiched between the input and output end plates.

10. The separation module of claim 9, wherein the pressure jacket includes separate drains for liquids and gases.

11. The separation module of claim 6, wherein the filter block consists of a plurality of filter plates stacked one behind the other and sandwiched between the input and output end plates.

12. A solid/fluid separation module for separating a pressurizable solid/fluid mixture, the separation module being constructed for use with a screw extruder having an extrusion barrel, an extruder block and a rotatable extruder screw fittingly received in the extruder barrel, the separation module comprising
a housing defining a pressurizable fluid collection chamber connectable at an input end to the extruder barrel and at an outlet end to the extruder block; and
a barrel defining an axial core opening for containing the pressurized solid/fluid mixture under pressure and connectable to the extruder barrel, the barrel being mounted in the housing and including a filter block;
the filter block forming at least an axial portion of the barrel and consisting of a plurality of stacked barrel plates;
each barrel plate having a flat front face, a flat rear face, an inner edge defining the core opening and extending from the front face to the rear face, and an outer edge for contact with the collection chamber and extending from the front face to the rear face, the barrel plates being tightly stacked in the filter unit for sealing engagement of the front and rear faces of adjacent filter unit plates to seal the core opening from the fluid collection chamber; and
at least one of the barrel plates being constructed as a filter plate having a filter passage recessed into the front face, the filter passage extending from the inner edge to the outer edge for draining fluid in the pressurized solid/fluid mixture from the core opening to the collection chamber.

13. The separation module of claim 12, wherein the inlet plate, outlet plate and filter plates define a core opening sealed from the collection chamber, for communicating with the extrusion barrel, the filter plate having at least one filter passage communicating with and extending away from the core opening and the separation chamber having a drainage outlet for draining liquids separated by the filter pack.

14. The separation module of claim 1, wherein the filter plate includes a plurality of filter passages with a pore size of 0.00003 to 0.005 square inch.

15. The separation module of claim 1, wherein the filter block has a porosity of 5% to 40% measured as the total pore area relative to the total filter surface.

16. The separation module of claim 14, wherein the filter block is constructed for operation at a pressure of 100 to 5000 psig,

17. The separation module of claim 16, wherein the filter block is constructed for operation at a pressure of 2500 to 3000 psig.

18. The separation module of claim 1, wherein the filter passage includes a directional deflection for blocking a straight line path through the filter passage.

19. The separation module of claim 18, wherein the filter passage has an inner end at the core opening and an outer end at the collection chamber and the deflection is positioned at, the inner end, the outer end, or at any point therebetween.

20. The separation module of claim 19, wherein the deflection is in the form of a S-shaped curve, a Z-shaped curve, or a split or fork in the filter passage in the form of a T-shaped, I-shaped, Y-shaped or U-shaped split.
